(19) United States
(12) Patent Application Publication
(10) Pub. No.: US 2012/0181979 A1
(43) Pub. Date: Jul. 19, 2012

(54) Telescoping Rechargeable Powered Pole System with Stand

(76) Inventors: James Daniel Hudspeth, (US); Chris McGilvray, (US)

(21) Appl. No.: 13/007,985

(22) Filed: Jan. 17, 2011

(51) Int. Cl. H02J 7/00; F16M 11/04; F16M 11/28

(52) U.S. Cl. 320/108; 248/157; 248/125.8

(57) ABSTRACT

A Telescoping Powered Rechargeable Pole with Stand System 1 with a any one of several devices mounted on the top of the pole that requires a certain level of direct current electric power to maintain it's operation. Usually in a remote place away from any other power source, the stand 2 can be set and the powered telescoping poles 3 and 5 can be raised to gain height for the device mounted on the top of the pole 3. A device mounted directly onto the top cap 30 and powered via a power cable 38 can be powered for a time and then the Telescoping Rechargeable Powered Pole with Stand System can then be recharged through the recharging power port 29. The top cap mount 35 connects the device the top of the pole. The system is powered for a length of time dictated by the size and number of battery cells contained within the top tube 3 of the powered telescoping pole with stand 1. The system is recharged via a suitable charger through the power recharge port 29. A benefit to having the power supply in the top tube 3 allows for 360-degree rotation of the powered device without being encumbered by wires that must reach past the point of contact to the pole structure holding the device. The top tube 3 acts as a support and a battery compartment as well. This tube 3 can be a sealed structural member and provide power to the top device simultaneously and spin freely without wire tangle.

### CROSS-REFERENCED TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Technical Field

This invention relates in general to a telescoping pole with a stand mechanism that provides direct current battery power to a source directly suited to be placed on the top of a quickly deployable telescoping stand, specifically a rechargeable battery powered telescoping pole with a minimum plurality of two or more particular length poles that nest one inside the other, the top telescoping pole being initially empty and with sufficient length and girth to encase an appropriate number of rechargeable battery cells to power various types of devices, suited specifically to being deployed quickly in any environment, the power source internalized inside the top tube. This configuration allows a unique 360-degree rotation of the top device and allows for unique searching opportunities as well as quick directional adjustments of devices attached to the top of the telescoping pole.

Some of the immediate uses for this type of deployable, rechargeable power source could be, but are not limited to spot lights, flood lights, LED lights of various colors and configurations as well as video surveillance cameras, or even temporary computer network access points and/or cell phone/radio repeaters. The only limitation to use of the technology is the level of the power requirement and the type of sensor our output device or even input device that is attached to the top of the device. Power can be provided an many different levels depending on size of Telescoping Tubes and the requirements of the device that is being powered.

The diameter of the top telescoping tube determines the size of the battery cells that can be inserted into the tube and the length of the tube determines the number of cells required for appropriate power levels, while various configurations, either parallel or in series, connecting the circuit with the negative terminal wire or wires routed along the battery path longitudinally to determine the amount of storable power and voltage available for the telescoping pole. Spacers inside the top telescoping tube can be added to separate voltage groups to set up for parallel wiring as well as spaces of the appropriate length to minimize the number of battery cells utilized in order to maintain telescoping poles overall height requirements.

In addition, the circuit could be completed with the housing as the ground wire. All of these components work together to supply a rechargeable battery powered telescoping pole that is lightweight, quickly deployed and can be configured for use with numerous electronic devices in many situations indoors and out.

Some of the initial uses for this technology seem to focus on the areas of consumer sporting goods camping industry, law enforcement/military applications as well as in the hunting industry. In addition, larger versions with plug in a solar re-charger could be utilized in long-term emergency situations, where temporary communications or lighting needs to be deployed.

2. Description of the Related Art

Many configurations of light systems with stands exist and were primarily designed with a method to hold the light, such as a stand or tripod and either a plug in AC power source or a DC power source in some sort of battery box. As the art indicates in U.S. Pat. No. 6,902,294, these batteries are typically housed in some type of external box of many variable shapes and sizes that adds weight and complexity to the product. Several of the systems depicted in prior art indicated utilize an ac power source that at a glance looks like a Telescoping Rechargeable Powered Pole with Stand System, however are very different in the functionality and capabilities inherent in the design of the present invention.

The addition of an integrated battery compartment typically depict various types of flashlights that each discriminate themselves from one another by various mechanisms for switching the power on and off, or even by shape, size and still other flashlight type devices discriminate themselves through features such as type of illumination output for an intended purpose such as U.S. Pat. No. 6,265,969. This prior art depicts a depicts a very small tripod with a battery located inside the lower center tube that lights up 360 degrees once pulled up to act as a traffic safety device. Even with a light attached to the top of the telescoping rechargeable power pole with Stand shares neither features nor function with this device.

Various work lights on record utilize tripods for holding the light up in a desirable location; however, the tripod and or telescoping pole have nothing to do with powering the lighting device. The tripod and telescoping poles function purely as a structural element and not any type of housing.

In one prior art disclosure, rechargeable batteries are stored inside each of the three legs of the tripod and a wire is sent to the top of the pole holding the lighting system. There are obvious improvements that are realized over this type of system with the design of the present invention. This system is specifically designed to use external wires to connect the batteries to a light device at the top of the pole and cannot be rotated freely like the present invention without wrapping up the wires and having the rotation become impeded by the wires attached to the legs of the tripod.

This prior art design is a good illustration of the utility of using the top tube of the telescoping tube to house the battery configuration since the power can be easily accessed where it will be needed at the top of the pole. This telescoping pole design allows for a compact storage of a quickly deployable pole that is very tall with a self contained power source available at the top while being able to spin around freely for adjustment while standing freely on it's folding stand.

The battery containment method utilized in the telescoping powered rechargeable pole with stand system has a very novel approach to the battery placement for telescoping stands and or tripods with telescoping pole systems. In effect, the novelty of the system is that upon first glance, it is unclear where the battery power is coming from. This is because the battery housing is actually part of the structure of the pole, internally contained and controlled at the top of the pole by any typical various means. Since this system is completely self-contained within the top pole, the top of the pole is exactly where the power will eventually be required, with an internally wired system and various options for circuit control. This powered telescoping system is a very convenient method for quickly deploying a device that can take advantage of a quick, portable, and tall installation.

One method would be a simple on/off switch. Another could be a remote control switch, which could enable defensive applications with the proper super bright light or perimeter sensor mounted on the top of the pole. And still a third could be a combination of both, or even some sort of motion detection. In all embodiments of the invention, there is some form of switch controlling current flow to various numbers of battery cells arranged in various configurations to deliver the proper voltage for the device that is specified.

Additionally, in the current embodiment of the invention there is an electrical connection port that allows for insertion of a recharging plug that is connected to the battery cells embedded in the top tube of the telescoping pole to allow many repeated uses without the need for replacing the batteries. The battery cells should be of sufficient size to utilize the full diameter of the top tube of the telescoping pole, and the wire should be of minimal thickness to allow easy installation of all the battery cells. As stated earlier, the housing could also be potentially utilized, in an effort to reduce costs and make the device without a ground wire, as the bottom of the battery cell would be connected to the housing via the bottom spring being in connection to the metal tube housing and the bottom of the battery cell.

There has been no prior art with regard to storing rechargeable batteries inside the top pole of a telescoping stack of poles and wiring them to power devices, which could be deployed in an expedient, and efficient manner has not been recognized thus far. U.S. Pat. No. 6,454,228 depicts using batteries inside of a tube, however it is in the bottom tube and depicts a spiral wound wire shooting up to the top of the tripod to power it's light. While this looks the same from the outside, it would be difficult to effectively engineer the wire to allow 360-degree spinning capability without the wire winding up and breaking. And even still, a telescoping pole design that has enclosed bottoms on the individual tubes such as the present embodiment of the invention allows a feature such as air-cushioned telescoping retraction to be utilized on the design if required.

There has been prior art for many of the features inherent in the design of the Telescoping Rechargeable Powered Pole with Stand. Using a simple wrap around rifle rest rod on the top tube of the telescoping pole, the rifle rest can rotate freely with a light on the top of the Telescoping Rechargeable Powered Pole with Stand System. This allows a very convenient situation in hunting application where shooting at night is legal and control of the light pole and rifle at the same time is warranted. U.S. Pat. No. 6,637,904 art depicts a specific type of police light with a structural tripod stand that has many convenient uses specific to the police including the use of the light for the rifle rest, however, functionality of the device in the prior art is very limited in adjustability as well as height in this type of situation. Essentially, the art depicts a device that is wireless, battery operated and attaches to multiple mounts and provides a completely different functionality than the present embodiment of the invention's many possible configuration as well as being vastly limited in it's possible usefulness for any type of other application.

Using the top tube of the telescoping pole for to double as a structural part of the device as well as the container part of the device is a great and novel design that provides a very useful and convenient place to store the power in a telescoping pole. In addition, the device is very easy to deploy in outdoor conditions, since in the absence of a variable length cord running the length of the telescoping pole from top to bottom where batteries are typically stored or the device is plugged in, virtually all snags and tangles are virtually eliminated with the telescoping rechargeable battery powered pole with stand system.

### OBJECT OF THE INVENTION

Thus, it is an object of the invention to provide a lightweight telescoping pole with sufficient internal batteries to power a wide number of various devices. The invention in its current embodiment would include provisions for some form of folding stand or some form of tripod system for quick deployment purposes.

It is another object of the invention to encase the battery cells inside the top tube of the telescoping pole to provide a ready made and self contained battery box type of arrangement. This convenient configuration is both novel and provides a sleek new way to use many devices that can be powered by the system and quickly deployed in possible remote locations.

It is another object of the invention to provide various levels of power based on the configuration of the battery stack inside the top tube of the telescoping pole. The power can be accessed in a number of ways. In various incarnations of a power port, and or a power cord that exits the top of the tube to be plugged into the device in need of power, or even directly wired from the cap.

It is another object of the invention to provide a method for controlling the power by use of a mechanical switch such as a miniature switch that could control a relay to handle higher current or just issue direct control of the circuit as the switch is capable to the task. The mechanical switch could also be used in conjunction with other switch controls such as with a wireless remote or motion detection technology to properly control the type of device that could be installed on top of the telescoping powered rechargeable pole.

It is another object of the invention to provide a means to recharge the battery cells such as a plug port installed near the top of the pole. With the typical length of the telescoping pole being of sufficient length to reach up higher into the air, a plurality of batteries are used to power the pole for longer timeframes. However it is possible to remove the top cap and replace the battery cells with non-rechargeable battery cells and still achieve the same functionally of the structure until the power is diminished in the non-rechargeable cells.

It is still another object of the invention to offer an externally or internally housed button operated and/or remote control switch operation for controlling power delivery to the device at the top of the telescoping pole. In this embodiment of the invention, a local mechanical switch and/or a wireless remote control transmitter and receiver could be employed either independently or in unison to control the current flow in the system. With enhanced electronic control, various levels of power output could be available with multiple pushes of the control button be it wireless or located near the top of the telescoping tube on the top cap.

It is another object of the invention to provide a means for securing the powered device to the top of the telescoping pole. This method could be any number of handy options. With lighting systems, some form of simple pivot or U-bracket attached to the top of the telescoping pole with a screw. Those skilled in the arts may describe a method for integrating a top cap into a bracket. If the device is non-directional, then the boxed device could be bolted into the top bolt hole locate in on the cap or even utilize the same U-bracket that is located at the top of the top tube of the telescoping pole.

It is finally another object of the invention to provide a 360-degree rotating top tube for quick adjustments and directional control with the top tube fully extended and locked into position with the quick adjustment knobs provided on the telescoping pole. Since the power cells are contained internally, there are no wires to unwind and there is no battery source to deal with as to impede the complete revolution of the top tube with the middle tube quick adjustment knob in the loose position. This configuration works easily on a telescoping pole with a plurality of 3 individual telescoping poles. The middle tube is left in the down position but loose in it's locking collar, and the top tube is fully or partially extended based on required height, and then locked into position with it's locking collar. This allows the top tube while raised in various heights up to full extension to pivot because of the middle tube being loose which provides incredible searching capabilities when coupled with an appropriate light source. When scanning with a light head on the top of the telescoping top tube, fatigue from holding the light is eliminated and a steady lighting source is obtained.

There are many devices that the Telescoping Rechargeable Powered Pole with Stand System can be adapted to work with in the field. Some of the scenarios that the present embodiment of the invention will provide include several new capabilities. In military situations, a non-lethal super bright blinding light can be attached to the top of a lightweight remote controlled Telescoping Rechargeable Powered Pole with Stand System and triggered remotely and instantly to blind dangerous approaching vehicles at checkpoints along a road. In hunting situations, the ability of the top tube to pivot 360-degrees inside the bottom tube allows the hunter to use a light to scan easily during the night hours—legal in many states for various species of animals. In the case of a video camera installed on the top of the telescoping pole, the direction can quickly be changed for quick field set up or even in a searching mode with high- resolution cameras. In the case of a directional antenna deployment, the antenna can be reoriented very quickly as well. All these devices benefit from the combination of the functionality of the internal battery containment in the top tube to reduce the weight, size and complexity of the device, but also the ability of the design that allows free-spinning directional adjustments of the telescoping pole and the easy set up that this design provides.

### BRIEF SUMMARY OF THE INVENTION

The Telescoping Rechargeable Powered Pole Stand System is a compact telescoping pole system with a quickly deployable tripod leg system made preferably from lightweight aluminum material, or any other structurally compatible material suited for the design. Internalized within the top tube of the telescoping plurality of tubes, the hollow top includes a bottom to the tube is filled with a plurality of batteries to meet the requirements DC powered devices, attached to the top of the telescoping pole, which requires some specific power input to operate properly, and are desirous to deploy quickly in remote locations.

### BRIEF DESCRIPTION OF THE VIEWS OF THE DRAWINGS

For a more complete understanding of the present invention, and the advantages thereof, reference is now made to the following descriptions taken in conjunction with the accompanying drawings, in which:

FIG. 1 illustrates the complete system with a side detail illustration, which depicts a partial cut-away view of the internal components required for the complete rechargeable telescoping power pole.

FIG. 2 illustrates a variation on the internal design of the top tube 3 describing the battery placement location, which includes a method for reducing the capacity of the tube to include a decreased plurality of battery cells.

FIG. 3 depicts a device installed on top of the pole that needs to be rapidly deployed, or easily used in the field and requires power for a limited time. Once the device is no longer required, it can be retrieved and can be connected to a charger, recharged in the appropriate fashion and readied for its' next deployment.

FIG. 4 depicts a video transmitting device for use where a video camera could be quickly installed and used for a time, and then retrieved. The powered telescoping pole provides a long duration, prescribed level of power for use with many different devices.

FIG. 5 depicts a cell phone-repeating device that could be used at a remote campsite, work site or in an emergency situation. The telescoping pole lends itself well to antenna deployment and can be used to extend the range significantly to the local area.

### DETAILED DESCRIPTION OF THE INVENTION

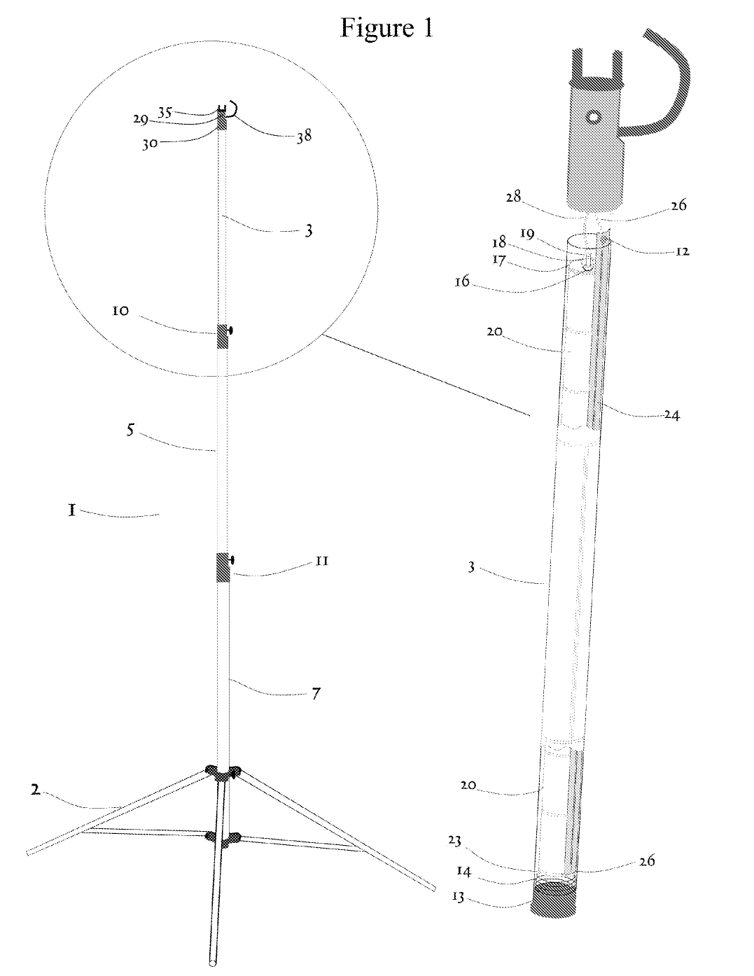

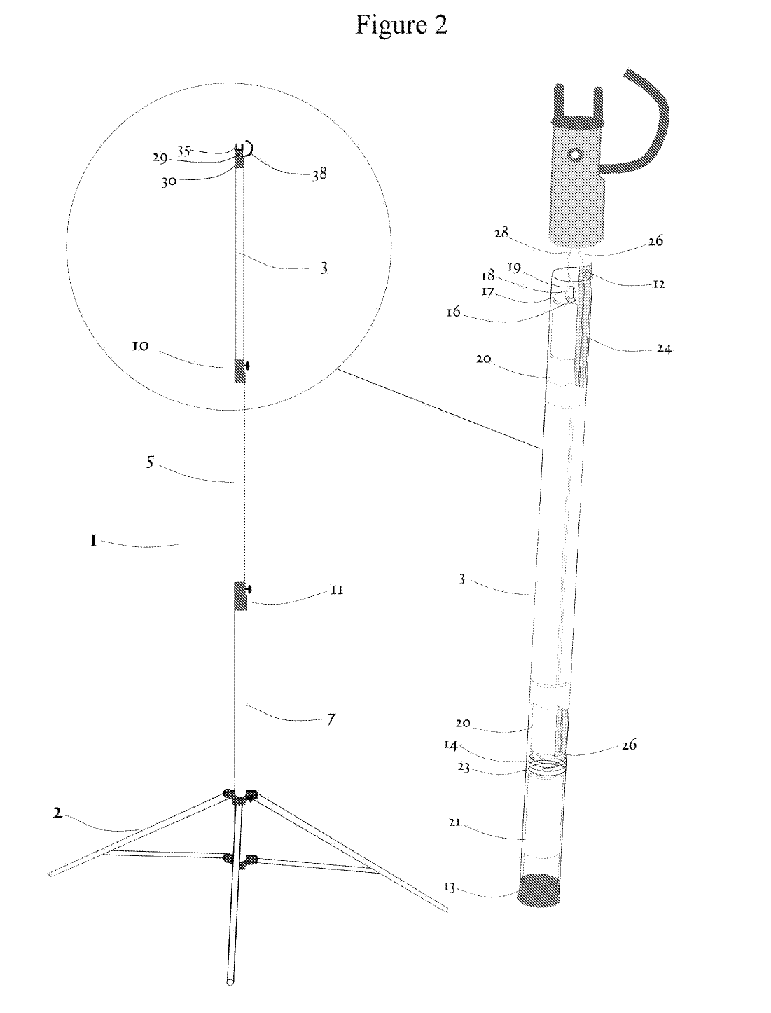

The present invention is best understood in relation to FIGS. 1 and 2 of the drawings, like numerals being used for like elements of the various drawings.

FIG. 1 illustrates a frontal view of the present invention with the most relevant components detailed from the overall view with a cutaway view on the right side of the page that details the components detailed in the diagram circle. The backbone of the invention is a telescoping stand system 1, which in the preferred embodiment is designed with an air-cushioned collapsing mechanism as well as an easy to fold tripod stand system 2 constructed of a lightweight materials with sufficient strength to sustain a moderate load at full extension in outdoor conditions. There are many variations on a telescoping stands that would be sufficient to use in this application. The model depicted 1 is of the proper size for a large number of power cells 20. Modifications to this standardized design for a telescoping stand makes possible for a novel design with respect to battery cell location. Since there are many types of telescoping stands, the structure of the present invention can be embodied in numerous ways and the one depicted is one design of many that could be employed to function in this capacity.

The various parts that constitute the backbone structure of the present invention include the upper telescoping tube 3, the middle telescoping tube 5, as well as the lower tube 7, on which the tripod leg assembly 2 is mounted. The illustration on the left side of the page depicts the main structural body of the invention. Many different products can be adapted and installed onto the top tube to be powered by the telescoping rechargeable stand system. The details of the telescoping stand system are commonly available and prior art suggests many designs of this type of structure. Therefore, many types of telescoping stands can be interchangeably employed to suit the function of this invention and the details of this component have been omitted as they are not particularly within the scope of this document.

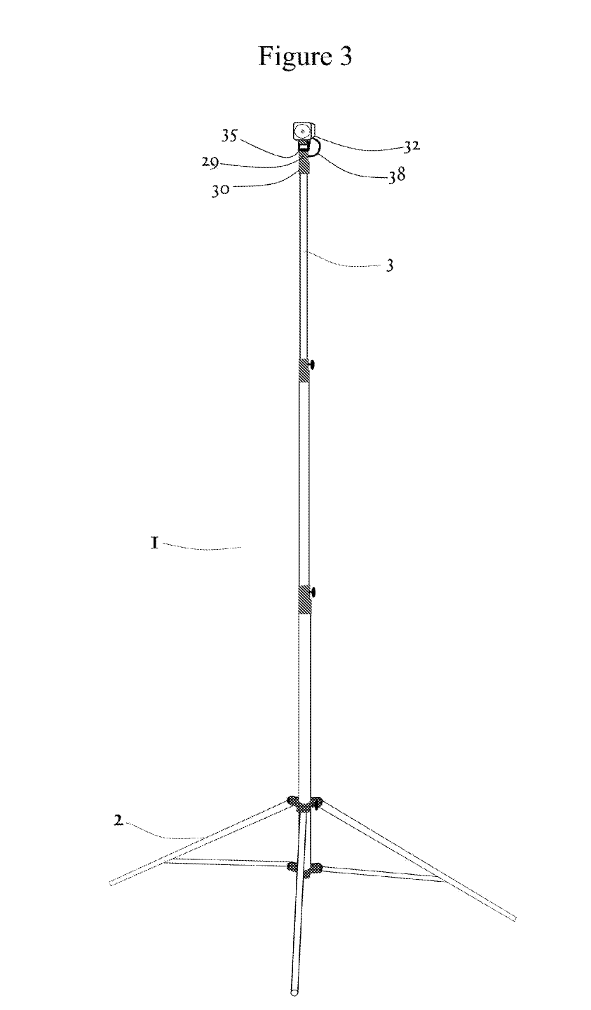

FIGS. 3, 4, and 5 demonstrate some of the typical devices that can be retrofitted to the top tube of the Telescoping Tube. With the proper mount, virtually any type of device can be attached and will function for a predetermined length of time.

The detail in the illustration on the right side of the page that depicts the internal components of the top tube 3 as shown with several partial cutaways due to the redundancy of components along the length of the top tube 3. Since the top tube 3 is removable, the detail depicts only this separate component.

As previously stated, the top tube 3 from the system of telescoping tubes is the novelty in the design since it is to be used as the battery compartment. This unique solution to battery placement makes perfect sense since any electronic device that is suitable for use on the telescoping rechargeable stand system should be connected to the very top of the telescoping pole. This happens to be where the power from the telescoping pole is provided. In addition, the telescoping pole, and hence the device installed at the crest of the telescoping pole can easily be rotated and effectively aimed in many directions, which aids in the functionally of rapid deployment.

As part of the manufactured telescoping pole, a plastic plug 13 is installed on the bottom of the tube. This plug includes a fabric bushing bolted to the plug 13, which is not depicted but is part of the air cushioning system of the telescoping tripod and is not part of the scope of this document. The first part installed into the tube 3 is a spring 14 of sufficient force and physical size to provide a proper suspension for the many battery cells 20 to be installed in the tube shortly. The spring stop 23 is a circular flat plastic disk of sufficient thickness to be rigid enough to contain the weight of the battery cells 20. This disk acts as the spring- loaded bottom end of the tube. Various designs could be utilized to achieve the same results, such some type of foam pad, a plastic insert with integrated plastic spring, or any other new type of spring combination that those skilled in the arts may craft for this purpose.

Once the power requirements for the particular device that will be placed on the top of the telescoping tube are specified, the battery design for the top tube 3 can be finalized and the appropriate quantity of battery cells 20 can be installed with the flat wire conductor 24 into the tube in a stacked properly oriented position. As depicted the flat wire is the negative conductor 24 that brings electrons from the negative terminal of the battery (at the bottom of the stack of battery cells 20) to the top of the tube 3. In this version, a flat wire 24 with an outer jacket that has adhesive on one side of the non-conducting sleeve is applied longitudinally along the stack of properly oriented battery cells and used to link the required number of battery cells 20 together with the bottom of the flat wire folded around the final bottom cell 26 and is exposed to the negative terminal of the bottom battery cell 20 and in fact is pressed against the negative terminal with pressure from the bottom tube suspension system. Once the adhesive on the negative conductor 24 is effectively linking all the batteries together, the assembly is slid into the top tube 3 and lowered into position against the bottom suspension system consisting of the plug 13, spring 16 and the plastic disk 23.

Various methods and components can be utilized to arrive at the same end functions of many different assemblies of this system, and those skilled in the arts may provide various solutions to improve production and still provide the same functionality. Included also in this solution is the method for attaching a device to the top tube. As depicted on the main illustration at the top of the tube is a top cap 30 which houses a means for attaching a device 35 to be powered as well as a port 29 to access the batteries cells 20 to be recharged. A power umbilical 38 is offered for connection to the various devices that might be powered by the invention as detailed in the following illustrations. The detail illustration in FIG. 1 depicts a method for connecting to the positive terminal of the stack of battery cells 20 is depicted, but is not limited to this configuration.

As shown, the positive connector 11 is comprised of a metal button connector 16, attached to a circular plastic washer 17, through the middle of which extends a wire of sufficient gauge to carry the required current to connect the button connector 16 to a circuit breaking device 18 which in turn is connected to a positive power supply wire 28. Additionally, a negative supply wire 26 is soldered 12 to the flat negative conductor 24 that stretches the length of the battery cells 20 and connects to the bottom of the stack where it is folded and the exposed conductor 26 maintains contact to the negative terminal of the plurality of battery cells 20 which are configured inside the top tube 3 in a stacked configuration.

FIG. 2 is almost identical to FIG. 1 with several modifications made to the stack of battery cells 20 that allow a decreased plurality of the battery cells 20. This will allow for various levels of power for various devices that require different voltages. FIG. 2 has the redundant component details omitted from the illustration and the new components that are required to implement this alternate method of stacking the batteries with care to assemble in the correct polarity, with the component delta notated to achieve this utilitarian design.

As depicted in the lower portion of the detailed section, the very bottom of the top tube 3 has a circular plug 13, which is affixed to the tube as a plug in a permanent fashion. Immediately stacked internally inside the tube 3 is the volumetric spacer 21 which is of sufficient longitudinal dimension to occupy the space required to lift the specified plurality of battery cells 20 that is matched to the device or load to be amassed at the pinnacle of the telescoping pole 3 to within a few inches of the complete space inside the top tube 3.

Once the volumetric spacer 21 is placed fully into the bottom of the top tube 3 and is in fact abutting against the bottom circular plug 13, a plastic circular disk 23 is installed onto the volumetric spacer 21, a spring is stacked into the top tube 3 of sufficient diameter to fit the inside dimension of the tube without friction, and of sufficient torque to suspend the battery cell 20 weight load. The remaining components are exactly the same type specifications and sizes to accommodate the battery cell 20 dimensions and required plurality versus voltage and capacity requirements.

With the addition of an additional flat negative conductor 24, typically exactly installed into the middle of the plurality of battery cells 20, it is possible to 386 arrange for a parallel wiring circuit to both reduce voltage and increase overall capacity. In addition, the order of the components can be reversed to place the battery at the bottom of the tube for better weight dispersion throughout the device.

FIG. 3 details a lighting device 32, which can be attached to the top of the Telescoping Rechargeable Powered Pole with Stand System 1 with a U-bracket 35 that allows the lighting device 32 to tilt up and down for adjustments. The internal components of the powered pole 1 are the same as in FIG. 1, with the full plurality of battery cells 20 that can fit into the top tube, to deliver maximum voltage and power reserves for many hours of operation. Most devices require a specific voltage, which can be achieved by varying the number of battery cells 20. The light head 32 receives its' power via a power connector wire 38, which comes out of the top cap 30. Also depicted is the charge port 29, in which a battery charger plug is inserted and used to charge the battery cells 20. Various methods for switching and wiring can be adopted and those skilled in the arts may suggest alternative arrangements other than those depicted in this document. For the purpose of this document, a simple on-off panel switch is employed to interrupt the connection between the direct current provided by the main power lead 38 and the lighting device 32.

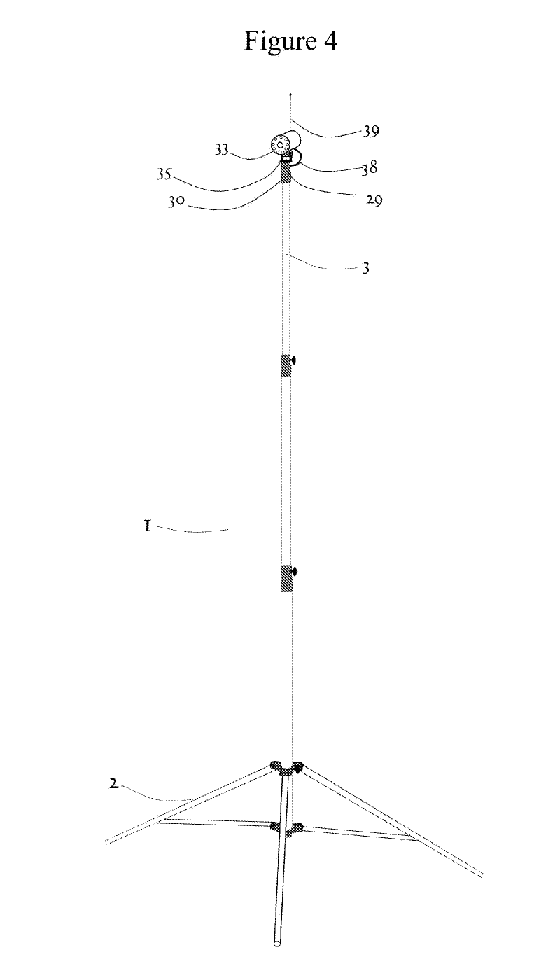

FIG. 4 illustrates another embodiment of the invention powers a Video Camera 33 for remote viewing activities with a requirement of a very short set up time using the Telescoping Powered Rechargeable Pole with Stand system 1. The video camera system 33 is mounted directly onto the top cap 30 and powered via a power cable 38. The top cap mount 35 connects the housing of the video camera system 33. The system is powered for a length of time dictated by the number of battery cells contained within the top tube 3 of the powered telescoping pole with tripod 1. The system is recharged via a suitable charger through the power charge port 29. The antenna system 39 is a component of the video camera system typically a component contained within the video camera 33 used for remote viewing of the camera feed.

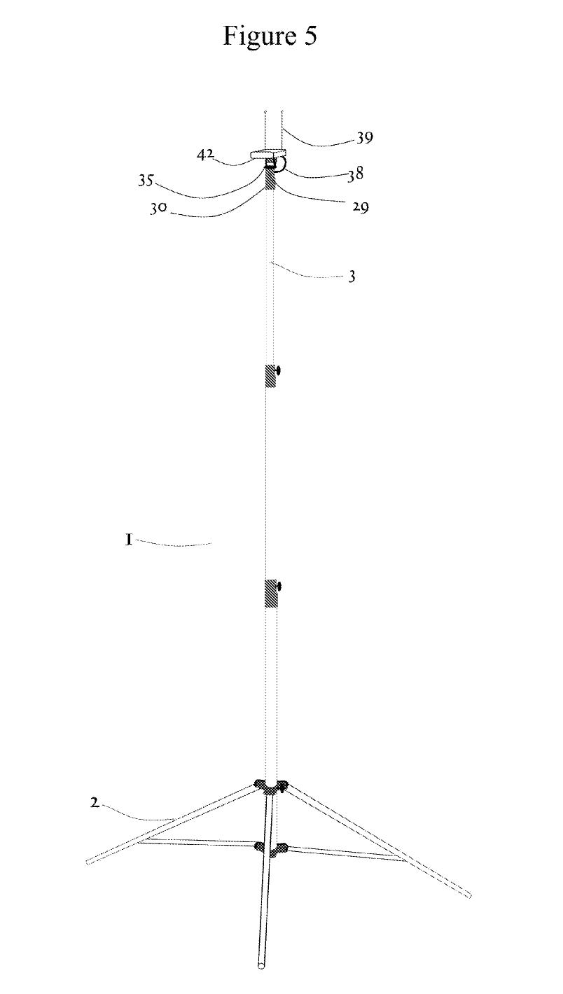

FIG. 5 depicts the Telescoping Powered Rechargeable Pole with Stand System 1 with a cell phone repeating system 42 mounted directly onto the top cap 30 and powered via a power cable 38. The top cap mount 35 connects the housing of the cell phone repeating system 42. The system is powered for a length of time dictated by the number of battery cells contained within the top tube 3 of the powered telescoping pole with tripod 1. The system is recharged via a suitable charger through the power charge port 29. The antenna system 39 is a component of the cell phone repeater system, one for the cell tower and one for the local cell phone to be boosted.

1. A telescoping pole consisting of a plurality of successively smaller diameter tubes and telescoping connectors to control extension forming a set telescoping poles, with the top tube of the pole containing a plurality of batteries or battery pack that allows the telescoping pole to power a device affixed to the top of the telescoping pole.

2. A telescoping pole according to claim 1 that has a battery pack inside the top tube wherein:
the top tube of the plurality of telescoping tubes is free to rotate independently and completely, unencumbered by power wires as it spins either in a set up and positioning scenario or
constant readjustment of top mounted device during actual use.

3. A telescoping pole according to claim 1 comprised of a plurality of tubes, wherein
the top tube is utilized as the top support structure and simultaneously as the battery compartment, which can be adjusted with various configurations of batteries or battery packs with various wiring options to deliver various levels of voltage and battery pack endurance.

4. A telescoping pole with a plurality of tubes, the top tube containing a rechargeable or disposable battery power source with or without a means of current control by way of a switching mechanism.

5. A rechargeable or disposable battery power source according to claim 4 wherein:
the means of current control may require apush button switch, a magnetic switch, a proximity switch or motion activation control, a tactile switch, or even any form of wireless remote control or combination thereof,
where the switching mechanism emanates from the top of the upper telescoping tube and controls the power circuit to the telescoping pole.
Certain load devices may include a switch internally and would not require additional current control features.

6. A rechargeable or disposable battery power source according to claim 4 wherein:
the recharging of the batteries inside the upper tube having batteries which are rechargeable has an electrical port or sealed unit type of inductive charging connection.
If the batteries are not rechargeable, the top tube in the telescoping pole has a means for replacing the batteries.

7. A powered telescoping pole-ultimately supporting a device connecting bracket with attached or detachable stand, that is easy to deploy in the field and is sufficient to erect the telescoping powered pole in a type of vertical or upright position perpendicular or otherwise to the ground easily

8. A powered telescoping pole ultimately supporting a device connecting bracket according to claim 7 such that
the top connector or system of contacts that allow a load device of matching voltage specifications to be mounted to the top of the telescoping tube, connected via an electrical connector, wherein:
the device can be extended upright with the intent of full directional articulation providing complete adjustability in both direction and height.

9. A powered telescoping pole ultimately supporting a device connecting bracket with an attached or detachable stand according to claim 7 wherein:
the detachable stand is preferably a tripod style stand with a plurality of structural legs with which to orient the powered telescoping pole upright.
